(19) United States
(12) Patent Application Publication
(10) Pub. No.: US 2008/0129685 A1
(43) Pub. Date: Jun. 5, 2008

(54) Touch Selection Device

(76) Inventors: Cedric Bertolus, Montrouge (FR); Frederic Falletta, Le Kremlin Bicetre (FR)

Correspondence Address: MILES & STOCKBRIDGE PC, 1751 PINNACLE DRIVE, SUITE 500, MCLEAN, VA, 22102-3833, US

(21) Appl. No.: 11/661,699

(22) PCT Filed: Jul. 12, 2005
(86) PCT No.: PCT/FR05/01805

§ 371 Date: Jan. 16, 2008

(30) Foreign Application Priority Data
Sep. 2, 2004 (FR) 0409308

(51) Int. Cl. G06F 3/033

(52) U.S. Cl. 345/156

(57) ABSTRACT

The invention concerns a selection device (20) of an element among a list of elements of a graphical user interface (INT) intended to be displayed on a screen (2), including a navigation means in the list and a validation means (11) of the said selected element, characterised in that the navigation means includes a tactile strip (10) with tactile navigation zones (B, C) located on both side of a central neutral zone (A) which, by means of maintaining a point of contact on the said tactile navigation zones, allows continuous scrolling in the list, in either direction respectively, where the speed of the said scrolling increases with the distance of the position of the said point of contact from the central neutral zone.

This present invention generally concerns the technical field of user interfaces, in particular the graphical user interfaces of the hierarchical menus type, meaning menus in which certain elements can provide access to submenus.

More precisely, the invention concerns a selection device of an element among a list of elements in a graphical user interface intended to be displayed on a screen, including a navigation means in the list and a validation means of the selected element.

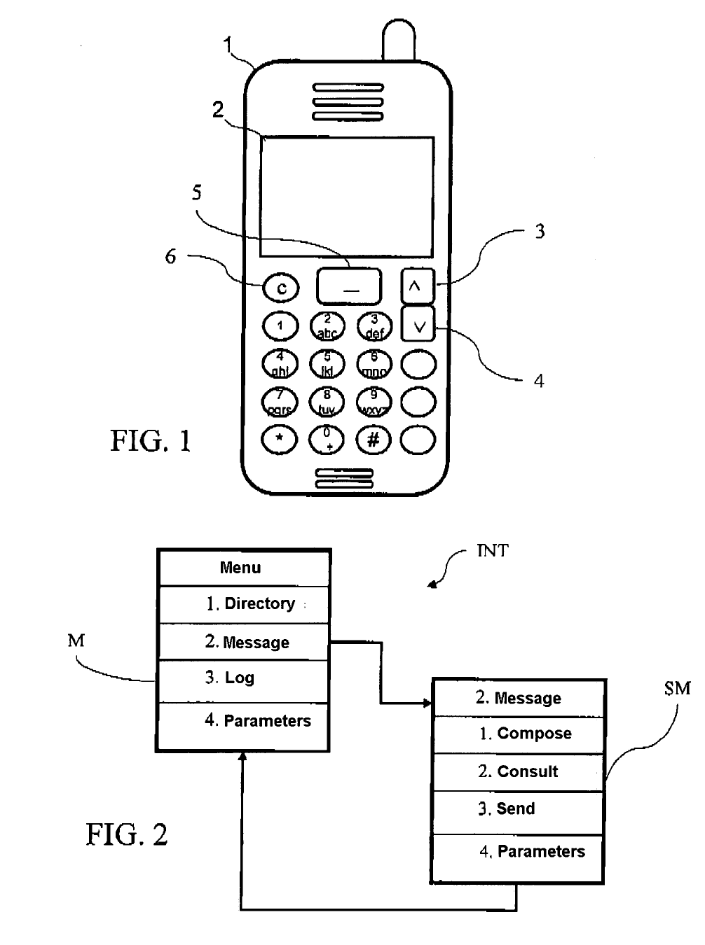

Devices of this type are known from previous designs, and are used in particular for navigating in a list of elements, the validation of an element, and moving backwards in the selection. One of these devices, which is the most widespread, is represented in FIG. 1, illustrating a mobile telephone 1.

A graphical interface to hierarchical menus (INT), as shown in FIG. 2, can be displayed on the screen 2 of the telephone, allowing the user to communicate with the telephone.

The selection device built into the telephone is conventionally composed of an “Up” arrow key 3 and a “Down” arrow key 4 for navigating, with a validation key 5 and a return key 6. Thus, a press on key 3 is used to move upwards the selection of an element in the menu displayed on the screen. Conversely, a press on key 4 is used to move downwards the selection of an element in the menu displayed on the screen. A press on the validation key 5 is used to validate the selected element and thus to gain access to the presentation of the corresponding submenu or to the function of the selected element, depending on the circumstances. The return key 6 is used to go back to the previous menu.

Taking the example of the graphical interface of FIG. 2, a first displayed menu M includes the elements “Directory” “Message”, “Log” and “Parameters”. The user moves the selection onto the “Message” element using key 4, and then, after validation, accesses the corresponding submenu SM which has the elements “Compose”, “Consult”, “Send” and “Parameters”. In like manner, the user navigates among the elements of the submenu using the Up and Down arrow keys to select one of these, and can go back to the previous menu by means of the return key.

Such a selection device, based on the use of arrows, involves step by step navigation among the elements of the menu. Navigating in this way can rapidly become laborious for the user, particularly in menus with a long list of elements.

In addition, selection devices equipped with a navigation means based on using a thumbwheel have appeared, allowing faster navigating and thus rendering the device more efficient than when using simple arrow keys.

However, such a navigation means does not allow continuous navigation through the menu. A to-and-fro action by the user on the thumbwheel is necessary. The use of a thumbwheel therefore also proves to be relatively difficult in menus that have a large number of elements.

The navigation means of the selection devices in the state of the art therefore do not allow to move very rapidly through a large number of elements in a graphical user interface with hierarchical menus.

In this context, the aim of this present invention is to overcome the aforementioned drawbacks.

To this end, the device of the invention, which in fact conforms to the generic definition given in the above preamble, is essentially characterised in that the navigation means includes a tactile or touch strip comprising tactile navigation zones located on both side of a central neutral zone which, by means of maintaining a point of contact on the said tactile navigation zones, allows continuous scrolling in the list, in either direction respectively, where the speed of the said scrolling increases with the distance of the position of the said point of contact from the central neutral zone.

Advantageously, the tactile navigation zones also include a neighbouring zone of the central neutral zone, allowing step-by-step scrolling in the list, in either direction respectively, by a brief contact on either said neighbouring zone.

Again advantageously, the tactile navigation zones include a peripheral zone which, by brief contact on the latter, allows screen-by-screen scrolling of the list, in either direction respectively.

The device also preferably includes tactile means for indicating the position of the neighbouring zones.

The device also preferably includes tactile means for indicating the position of the central neutral zone.

According to one method of implementation, validation means of the selected element includes a tactile validation zone in the central neutral zone.

Advantageously, the device includes a means for returning to the list once validation has been effected.

According to one method of implementation, the strip is positioned in a circular arc.

According to another method of implementation, the strip is positioned vertically.

The invention also concerns a terminal, characterised in that it includes a selection device of the type above described.

The invention again concerns a remote-control device, characterised in that it includes a selection device of the type just described.

Other characteristics and advantages of this present invention will appear more clearly on reading the description that follows, which is provided by way of an illustrative and non-limiting example only, and with reference to the appended figures in which:

FIG. 1 illustrates a mobile telephone comprising a selection device in a menu, according to the state of the art, which has already been described;

FIG. 2 illustrates an example of a graphical user interface employing hierarchical menus, which has already been described;

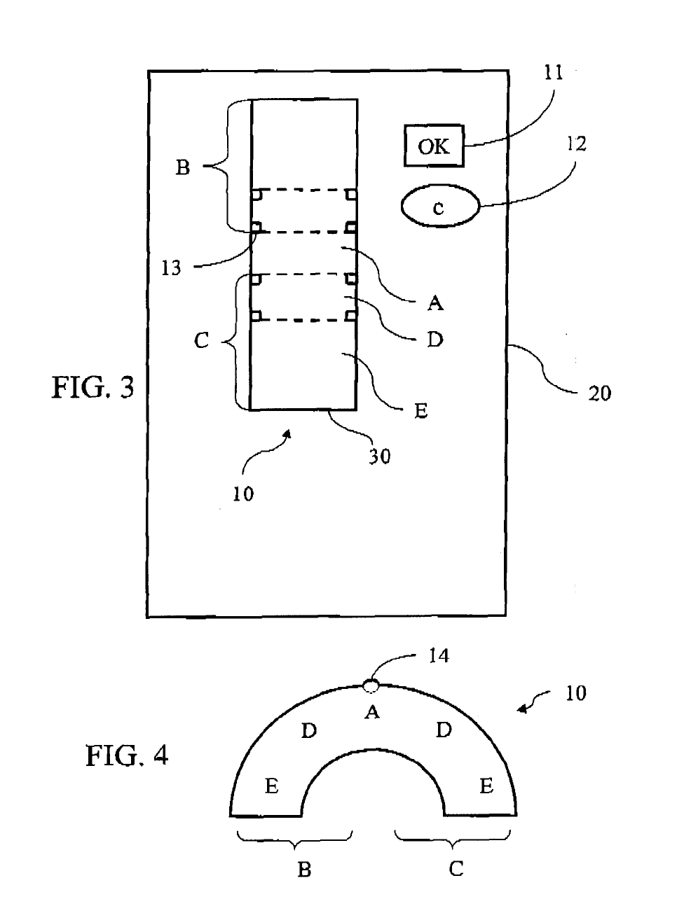

FIG. 3 schematically illustrates a selection device of an element of a hierarchical menu interface according to one embodiment present of the invention,

FIG. 4 illustrates an other embodiment of the selection device according to the invention.

FIG. 3 therefore describes a selection device 20 of an element among a list of elements in a graphical user interface comprising menus, in particular of the hierarchical type, as described in FIG. 2. The user interface is intended to be displayed on the screen of a terminal, with which the selection device is designed to operate, thus providing the user with means for navigating among the elements of the displayed menu.

The navigation means comprise a strip 10 that includes tactile navigation zones B and C located on both side of a central zone A. The tactile navigation zones B and C include means for interpreting action on a point of contact, effected preferably by the finger of the user on the latter, so as to allow scrolling of the selection in the list displayed on the screen, according to the action of the finger of the user on the tactile zones B and C.

The central zone A of the strip 10 is neutral regarding the scrolling of the selection displayed to the screen. Thus, action on this zone does not control any scrolling of the selection.

It should therefore be noted that the tactile strip 10 can assume a variety of forms. According to the example of FIG. 3, the strip is positioned vertically. Thus, when the user acts on the lower tactile zone C of the vertical strip 10, the selection moves downwards in the list. Conversely, when the user acts on the upper tactile zone B of the vertical strip 10, the selection moves upwards in the list.

According to another method of implementation, illustrated in FIG. 4, the tactile strip 10 could also be positioned in a circular arc, preferably horizontal. For example, when the user acts on the tactile zone C on the right of the arc, the selection moves downwards in the list. Conversely, when he acts on the tactile zone B located on the left of the arc, the selection moves upwards in the list.

The tactile strip 10 is built into a cavity 30 designed to accommodate it on the selection device.

Tactile means 14, shown in FIG. 4, for indicating the position of the central neutral zone A in the strip 10 are also provided, in such a way that the latter is easily perceptible to the user by feel. These indicating tactile means can, for example, take the form of a raised area created on the surface of the cavity walls 30 accommodating the tactile strip 10 at the position of the central zone A. However, any suitable means allowing the user to recognise the position of the neutral central zone on the strip 10 by feel could be envisaged.

The scrolling of the selection in a list of elements displayed on the screen will now be described in greater detail.

According to one characteristic of the invention, the selection moves differently according to the action on a point of contact, in this case the finger of the user, on the tactile navigation zones B and C of the tactile strip 10. The operation will be explained with reference to tactile zone C, and since the operation of zone B is perfectly symmetrical, only the direction of scrolling generated in the list differs.

Thus, when the finger is maintained on the tactile zone C, the interpretation means are designed to cause continuous scrolling of the selection point in the list of elements displayed, until such time as the user moves his finger toward the central neutral zone or breaks the contact with the tactile strip.

The action of the user's finger can start from the central zone A or by making contact with any given point on the tactile zone.

The speed of the continuous scrolling of the selection in the list is designed to increase as the position of the finger maintained on the strip is distant from the central zone A of the strip. The speed therefore increases as the position of the finger maintained on the strip moves away from the central zone of the strip toward its periphery. The user thus has considerable flexibility in his control over scrolling in the list, from a low speed up to a high speed, this being particularly advantageous in the case of menus composed of a long list of elements.

The tactile zone C can be divided into two zones: a neighbouring zone D of the central neutral zone, and a peripheral zone E. Tactile means 13 to aid the user are then provide in order to indicate and outline the position of the neighbouring zone D on the strip. By example, the indication means 13 can be formed by two hemispheres placed on the lip of the cavity 30 in contact with the strip 10 at the limits of the zone D.

When the user's finger makes a brief contact with the neighbouring zone D, the means for interpreting of the tactile zone are configured to control scrolling of the selection point in a step-by-step manner in the list.

On the other hand, when the user's finger makes a brief contact on the peripheral zone E, the means for interpreting of the tactile zone are configured to control the movement of the selection point screen by screen.

Thus, depending on the type of action of the user's finger, that is whether the contact is maintained or brief, and on its position on the tactile zone, scrolling of the selection point in list in a step-by-step manner, screen by screen, or continuously, and at varying speed, can be achieved, and in either direction, according to the tactile zone employed.

A validation means 11 of the selected element and a means for moving backwards 12, used to return to the list after validation of the selection has been effected, are also provided on the selection device. These means can take the form of control buttons available close to the tactile strip 10. However, according to a variant, the validation means 11 is composed of a validation tactile zone on the central neutral zone, allowing validation of the selected element in the list when the user effects a brief press on the neutral zone of the tactile strip 10.

The device according to the invention is particularly suitable for mobile applications in which the movement reduces the precision of the user's actions. For example, it can be incorporated advantageously into mobile telephones or other types of mobile communication terminals that have graphical user interfaces comprising hierarchical menus.

It is also suitable for situations in which the user's attention is limited or his physical posture is very relaxed, typically when watching television. Thus, the selection device according to the invention can advantageously be incorporated into a television remote control unit or any other appliance of similar type.

The selection device could also be connected to a terminal such as a computer, either by line or by wireless, over a Bluetooth link for example.

1. A selection device configured to select an element from a list of elements of a graphical user interface which is configured to be displayed on a screen, the selection device comprising means for navigating the list and a means for validating said selected element,
wherein the navigation means comprises a tactile strip with tactile navigation zones respectively located on both sides of a central neutral zone which, by means of maintaining a point of contact on the said tactile navigation zones, allows continuous scrolling in the list in either direction respectively, and the speed of the said scrolling increases with the distance of the position of the said point of contact from the central neutral zone.

2. A device according to claim 1, wherein the tactile navigation zones each include a neighbouring zone of the central neutral zone which, by brief contact on either said neighbouring zone, allows step-by-step scrolling in the list, in either direction, respectively.

3. A device according to claim 1, wherein the tactile navigation zones each include a peripheral zone which, by brief contact on either said peripheral zone, allows screen-by-screen scrolling of the list, in either directions respectively.

4. A device according to claim 2, further comprising tactile means for indicating the position of the neighboring zones.

5. A device according to claim 1, further comprising tactile means indicating the position of the central neutral zone.

6. A device according to claim 1, wherein said means for validating of the selected element includes a tactile validation zone in the central neutral zone.

7. A device according to claim 1, further comprising means for returning to the list once validation had been effected.

8. A device according to claim 1, wherein the tactile strip is positioned in a circular arc.

9. A device according to claim 1, wherein the tactile strip is positioned vertically.

10. A terminal including a selection device configured to select an element from a list of elements of a graphical user interface which is configured to be displayed on a screen, the selection device comprising means for navigating the list and a means for validating said selected element,
wherein the navigation means comprises a tactile strip with tactile navigation zones respectively located on both sides of a central neutral zone which, by means of maintaining a point of contact on the said tactile navigation zones, allows continuous scrolling in the list in either direction respectively, and the speed of the said scrolling increases with the distance of the position of the said point of contact from the central neutral zone.

11. A terminal according to claim 10 wherein the terminal is a mobile telephone.

12. A remote-control device including a selection device configured to select an element from a list of elements of a graphical user interface which is configured to be displayed on a screen, the selection device comprising means for navigating the list and a means for validating said selected element,
wherein the navigation means comprises a tactile strip with tactile navigation zones respectively located on both sides of a central neutral zone which, by means of maintaining a point of contact on the said tactile navigation zones, allows continuous scrolling in the list in either direction respectively, and the speed of the said scrolling increases with the distance of the position of the said point of contact from the central neutral zone.
